(19) United States
(12) Patent Application Publication
(10) Pub. No.: US 2024/0369741 A1
(43) Pub. Date: Nov. 7, 2024

(54) HIGH SCRATCH-RESISTANT AND ANTI-FOG COMBINED OPTICAL LENS DEVICE AND MANUFACTURING METHOD THEREOF

(71) Applicant: FORESIGHT OPTICAL LTD., Tainan (TW)

(72) Inventors: TIEN-SHU WU, Tainan (TW); YEN-TING WU, Tainan (TW)

(21) Appl. No.: 18/649,635

(22) Filed: Apr. 29, 2024

(30) Foreign Application Priority Data
May 2, 2023 (TW) 112116205

(51) Int. Cl. G02B 1/14; G02B 1/18

(52) U.S. Cl. CPC G02B 1/14; G02B 1/18

(57) ABSTRACT

A manufacturing method for optical lens devices includes: providing a scratch-resistant layer on a first outer surface of a first interchangeable optical layer to form a scratch-resistant interchangeable optical layer; providing an anti-fog layer on a second outer surface of a second interchangeable optical layer to form a second anti-fog interchangeable optical layer; fixing the first interchangeable optical layer and the second anti-fog interchangeable optical layer to form a combined dual optical layer; forming a thermal-isolated space layer between a first inner surface of the first interchangeable optical layer and a second inner surface of the second anti-fog interchangeable optical layer; and utilizing the scratch-resistant layer and the thermal-isolated space layer to prevent thermal-exchanging between the first inner surface of the first interchangeable optical layer and the second inner surface of the second anti-fog interchangeable optical layer.

### BACKGROUND OF THE INVENTION

### 1. Field of the Invention

The present invention relates to a high scratch-resistant and anti-fog combined optical lens device and manufacturing method thereof. Particularly, the present invention relates to an interchangeable scratch-resistant and anti-fog combined optical lens device and manufacturing method thereof.

### 2. Description of the Related Art

Taiwanese Patent Publication No. M521183, entitled “Ski goggle combination structure,” discloses a ski goggles combination structure, including a goggles frame, a plurality of first magnet components, a lens frame and a plurality of second magnet components provided to attract the plurality of first magnet components.

As described above, the goggles frame has a front portion and a lens combination hole provided thereon, with the lens combination hole formed from a combination through-hole extending through a lens member. The lens combination hole has a lens combination portion in which to contain the plurality of first magnet components.

Furthermore, the lens frame correspondingly combines with the lens combination portion of the goggles frame, with a goggles lens provided in the lens frame as well as a single-layer lens design provided. The lens frame is provided with the plurality of second magnet components which are corresponding to the plurality of first magnet components of the lens frame such that the plurality of first magnet components and the plurality of second magnet components attract each other for combination.

Another Taiwanese Patent Publication No. M589803, entitled “Composite-type lens combination structure for goggles,” discloses a composite-type lens combination goggles structure, including a front-side goggles lens, a rear-side goggles lens and a space-apart separating frame.

As described above, the front-side goggles lens has a rear surface and the space-apart separating frame is a hollow ring frame which has an inner circumference and a front surface. The space-apart separating frame further has a first predetermined thickness. The rear-side goggles lens has a second predetermined thickness, with the first predetermined thickness greater than the second predetermined thickness.

Furthermore, the inner circumference of the space-apart separating frame surrounds and engages with a circumferential edge of the rear-side goggles lens such that the front surface of the space-apart separating frame simply combines with the rear surface of the front-side goggles lens so as to form a predetermined space therebetween as well as a simple structure of anti-fog space to prevent generating fog on the rear-side goggles lens through the front-side goggles lens.

Furthermore, the anti-fog space is provided to prevent thermals of the front-side goggles lens transmitting to the rear-side goggles lens but the simple structure of the anti-fog space cannot effectively isolate directly thermal transmittance between the front-side goggles lens and the rear-side goggles lens. Namely, both of the front-side goggles lens and the rear-side goggles lens has a poor characteristic of thermal exchange isolation. In addition, scratches may be easily formed on an outer surface of the front-side goggles lens which is hit or scratched by objects while using.

However, the single-layer lens of the ski goggles combination structure, described in TW-M521183, or the simple structure of anti-fog space of the composite-type lens combination goggles structure, described in TW-M589803, only provide a lens combination structure which does not provide any interchangeable optical layer and a function of thermal exchange isolation.

Another Taiwanese Patent Publication No. 1752471, entitled “Scratch-resistant optical lens device with laminated glass/plastic composites,” discloses a laminated glass/plastic-composite scratch-resistant optical lens device, including a functional layer, a first scratch-resistant protective layer and a second protective layer.

As described above, the functional layer has a first front side surface and a second rear side surface, with forming the first scratch-resistant protective layer on the first front side surface to provide a scratch-resistant protection function or property on the first front side surface of the functional layer.

Furthermore, the second protective layer, corresponding to the first scratch-resistant protective layer, is formed on the second rear side surface, corresponding to the first front side surface, to provide a protection function or property on the second rear side surface of the functional layer, with the scratch-resistant protection function of the scratch-resistant protective layer having a degree greater than or equal to that of the second protective layer.

Another Taiwanese Patent Application Publication No. 201502600, entitled “Photochromic composite lens,” discloses a photochromic composite lens device, comprising a front side lens, a rear side lens, an intermediate layer and a functional coating layer. Provided between the front side lens and the rear side lens is a supporting structure to thereby form the intermediate layer.

As described above, the front side lens is provided on an outer side while the rear side lens is provided on an inner side. The intermediate layer is made of a photochromic dye material and the supporting structure defines a uniform thickness space such that the photochromic dye material filled in the uniform thickness space provides a uniform thickness layer.

Furthermore, the front side lens has an outer side surface on which to selectively combine with a first functional coating layer while the rear side lens has an inner side surface on which to selectively combine with a second functional coating layer.

Another U.S. Pat. No. 5,116,684, entitled “Composite ophthalmic lens,” corresponding to Taiwanese Patent Publication No. 215476, discloses a composite ophthalmic lens device, comprising an inorganic glass layer, a rigid, organic plastic layer and a silicon gasket, with the rigid, organic plastic layer selected from an optically clear, epoxy polymer material.

As described above, the optically clear, epoxy polymer material is formed from an aliphatic and/or aromatic epoxide monomer, a curing agent, a source of active hydroxyl group and an accelerator, and has a predetermined refractive index. The ratio of curing agent to epoxy, by equivalent weights, is between 2:5 to 5:4, the ratio of curing agent to source of active hydroxyl group, by equivalent weights, is between 2:1 to 6:1, and the amount of accelerator is at least 0.01%, but no over 1.0%, of the mixture.

FIG. 1 shows a schematic side view of a composite ophthalmic lens device described in U.S. Pat. No. 5,116,684 in accordance with the prior art. Turning now to FIG. 1, the composite ophthalmic lens device has a structure comprised of the inorganic glass layer, the rigid, organic plastic layer and the silicon gasket to cast a casting mix such that no functional optical layer is formed among the inorganic glass layer, the rigid, organic plastic layer and the silicon gasket.

Another Taiwanese Patent Publication No. 346442, entitled “Composite plastic optical quality lenses and method for making the same,” corresponding to U.S. Pat. No. 5,702,819, discloses a first composite plastic lens device, comprising a plastic lens preform portion and a cured plastic attached portion.

As described above, the plastic lens preform portion is molded from an optical quality material, with the cured plastic attached portion bonded to the plastic lens preform portion. In comparison with the optical quality material of plastic lens preform portion, a resin composition of the cured plastic attached portion has a higher scratch resistance, a lower chromatic aberration, and/or a high ease of edging than those of the plastic lens preform portion. The resin composition of the cured plastic attached portion has a refractive index within about 0.05 units of refractive index of the plastic lens preform portion.

Furthermore, Taiwanese Patent Publication No. 346442 also discloses a second composite plastic lens device, comprising a plastic lens preform portion which is made of aromatic polycarbonate polymer and a cured plastic attached portion which is made of resin composition.

As described above, the resin composition of cured plastic attached portion has a first resin portion and a second resin portion, with the first resin portion comprising bisallyl carbonate, with the second resin portion selected from a group consisting of one or more multi-functional acrylates, one or more multi-functional methacrylates and a mixture of one or more multi-functional acrylates and one or more multi-functional methacrylates.

In the second composite plastic lens device, in comparison with the optical quality material of plastic lens preform portion, the resin composition of cured plastic attached portion has a higher scratch resistance, a lower chromatic aberration, and/or a high ease of edging than those of the plastic lens preform portion. The resin composition of the cured plastic attached portion also has a refractive index within about 0.05 units of refractive index of the plastic lens preform portion.

Another Taiwanese Utility-Model Patent Publication No. M263511, entitled “Composite lens structure having a polarization thin film,” discloses a composite lens structure device, comprising an outer side lens, an inner side lens and a polarization thin film.

As described above, the outer side lens is formed from a first preform arc-shaped lens piece, with having an inner edge surface and an inner edge cambered surface, with the inner edge cambered surface defining (R2). The inner side lens is formed from a second preform arc-shaped lens piece, with having an outer edge surface and an outer edge cambered surface, with the outer edge cambered surface defining (R3).

The inner edge cambered surface defining (R2) of outer side lens is identical with the outer edge cambered surface defining (R3) of inner side lens. The polarization thin film is formed from a film body, with having an upper surface and a lower surface. The upper surface is provided with a first adhesive coating layer while the lower surface is provided with a second adhesive coating layer. The polarization thin film is adhered between the inner side lens and the outer side lens to perform a polarization effect of composite lens structure device.

Another U.S. Pat. No. 4,793,703, entitled “Laminated glass lens,” corresponding to Taiwanese Patent Publication No. 215476, discloses a laminated glass/plastic composite device, comprising an inorganic glass layer, an organic plastic layer and an adhesive layer.

FIG. 2 shows a schematic side view of a laminated glass/plastic composite device described in U.S. Pat. No. 4,793,703 in accordance with the prior art. Turning now to FIG. 2, the inorganic glass layer of laminated glass/plastic composite device is formed as a glass front surface layer while the organic plastic layer of laminated glass/plastic composite device is formed as a plastic back surface layer.

As described above, a first structure of the laminated glass/plastic composite device is simply formed from the inorganic glass layer, the organic plastic layer and the adhesive layer which are not interchange components, with none of which being provided with a functional thin film, as best shown in FIG. 2.

Still referring to FIG. 2, an assembly of the inorganic glass layer, the organic plastic layer and the adhesive layer do not provide thermal-isolation thin film layer or thermal-isolation space to prevent thermal exchange between optical layers.

FIG. 3 shows a schematic side view of another laminated glass/plastic composite device described in U.S. Pat. No. 4,793,703 in accordance with the prior art. Turning now to FIG. 3, the laminated glass/plastic composite device comprises an inorganic glass layer, a first organic plastic layer, a second organic plastic layer, a first adhesive layer and a second adhesive layer which are not interchange components.

Still referring to FIG. 3, an assembly of the inorganic glass layer, the first organic plastic layer, the second organic plastic layer, the first adhesive layer and the second adhesive layer do not provide thermal-isolation thin film layer or thermal-isolation space to prevent thermal exchange between optical layers. As described above, a second structure of the laminated glass/plastic composite device is simply formed from the inorganic glass layer, the first organic plastic layer, the second organic plastic layer, the first adhesive layer and the second adhesive layer, with none of which being provided with a functional thin film, as best shown in FIG. 3.

However, there is a need of improving the conventional composite lens devices or structures for providing a composite high scratch-resistant optical lens device and manufacturing method thereof. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide a high scratch-resistant and anti-fog combined optical lens device and manufacturing method thereof. A scratch-resistant layer is provided on a first outer surface of a first interchangeable optical layer to form a scratch-resistant interchangeable optical layer. An anti-fog layer is provided on a second outer surface of a second interchangeable optical layer to form a second anti-fog interchangeable optical layer. The first interchangeable optical layer and the second anti-fog interchangeable optical layer are fixed to form a combined dual optical layer. A thermal-isolated space layer is formed between a first inner surface of the first interchangeable optical layer and a second inner surface of the second anti-fog interchangeable optical layer. An arrangement of the scratch-resistant layer and the thermal-isolated space layer can prevent thermal-exchanging between the first inner surface of the first interchangeable optical layer and the second inner surface of the second anti-fog interchangeable optical layer. Advantageously, the optical lens device of the present invention is successful in providing interchangeable optical layers and avoiding thermal-exchanging between optical layers.

The high scratch-resistant and anti-fog combined optical lens device in accordance with an aspect of the present invention includes:
a first interchangeable optical layer having a first outer surface and a first inner surface;
a scratch-resistant layer provided on the first outer surface of the first interchangeable optical layer to form a scratch-resistant interchangeable optical layer;
a second interchangeable optical layer having a second outer surface and a second inner surface;
an anti-fog layer on the second outer surface of the second interchangeable optical layer to form a second anti-fog interchangeable optical layer;
a combined dual optical layer formed from fixing the first interchangeable optical layer and the second anti-fog interchangeable optical layer, with arranging the scratch-resistant layer on the first outer surface of the first interchangeable optical layer, with arranging anti-fog layer on the second outer surface of the second interchangeable optical layer; and
a thermal-isolated space layer formed between the first inner surface of the first interchangeable optical layer and the second inner surface of the second anti-fog interchangeable optical layer;
wherein the scratch-resistant layer and the thermal-isolated space layer are provided to prevent thermal-exchanging between the first inner surface of the first interchangeable optical layer and the second inner surface of the second anti-fog interchangeable optical layer.

In a separate aspect of the present invention, the first interchangeable optical layer has a first transmittance, a first color, a first pattern, a first mark, a first letter, a first number or combinations thereof.

In a further separate aspect of the present invention, the second interchangeable optical layer has a second transmittance, a second color, a second pattern, a second mark, a second letter, a second number or combinations thereof.

In yet a further separate aspect of the present invention, the thermal-isolated space layer is provided to contain at least one thermal isolation adhesive dot, at least one array of thermal isolation adhesive dots, at least one thermal isolation adhesive layer, at least one thermal isolation adhesive frame or combinations thereof.

In yet a further separate aspect of the present invention, the first interchangeable optical layer and the second interchangeable optical layer are assembled by at least one fixing member.

The manufacturing method for high scratch-resistant and anti-fog combined optical lens devices in accordance with another aspect of the present invention includes:
providing a scratch-resistant layer on a first outer surface of a first interchangeable optical layer to form a scratch-resistant interchangeable optical layer;
providing an anti-fog layer on a second outer surface of a second interchangeable optical layer to form a second anti-fog interchangeable optical layer;
fixing the first interchangeable optical layer and the second anti-fog interchangeable optical layer to form a combined dual optical layer;
forming a thermal-isolated space layer between a first inner surface of the first interchangeable optical layer and a second inner surface of the second anti-fog interchangeable optical layer; and
utilizing the scratch-resistant layer and the thermal-isolated space layer to prevent thermal-exchanging between the first inner surface of the first interchangeable optical layer and the second inner surface of the second anti-fog interchangeable optical layer.

In a separate aspect of the present invention, the anti-fog layer is selected from a protective layer, a filtering layer, an anti-UV layer, an anti-blue layer, an anti-blue purple layer, an anti-IR layer or combinations thereof.

In a further separate aspect of the present invention, the thermal-isolated space layer is processed in an assembling procedure to contain at least one thermal isolation adhesive dot, at least one array of thermal isolation adhesive dots, at least one thermal isolation adhesive layer, at least one thermal isolation adhesive frame or combinations thereof.

In yet a further separate aspect of the present invention, the first interchangeable optical layer and the second interchangeable optical layer are assembled or disassembled by at least one fixing member in an assembling or disassembling operation.

In yet a further separate aspect of the present invention, the combined dual optical layer is adjusted by selectively changing one of the first interchangeable optical layer and the second interchangeable optical layer in an assembling operation.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of a composite ophthalmic lens device described in U.S. Pat. No. 5,116,684 in accordance with the prior art.

FIG. 2 is a schematic side view of a laminated glass/plastic composite device described in U.S. Pat. No. 4,793,703 in accordance with the prior art.

FIG. 3 is a schematic side view of another laminated glass/plastic composite device described in U.S. Pat. No. 4,793,703 in accordance with the prior art.

FIG. 4 is a schematic side view of a high scratch-resistant and anti-fog combined optical lens device in accordance with a first preferred embodiment of the present invention.

FIG. 5 is a flow chart of a manufacturing method of high scratch-resistant and anti-fog combined optical lens device in accordance with a preferred embodiment of the present invention.

FIG. 6 is a schematic side view of a high scratch-resistant and anti-fog combined optical lens device in accordance with a second preferred embodiment of the present invention.

FIG. 7 is a schematic side view of a high scratch-resistant and anti-fog combined optical lens device in accordance with a third preferred embodiment of the present invention.

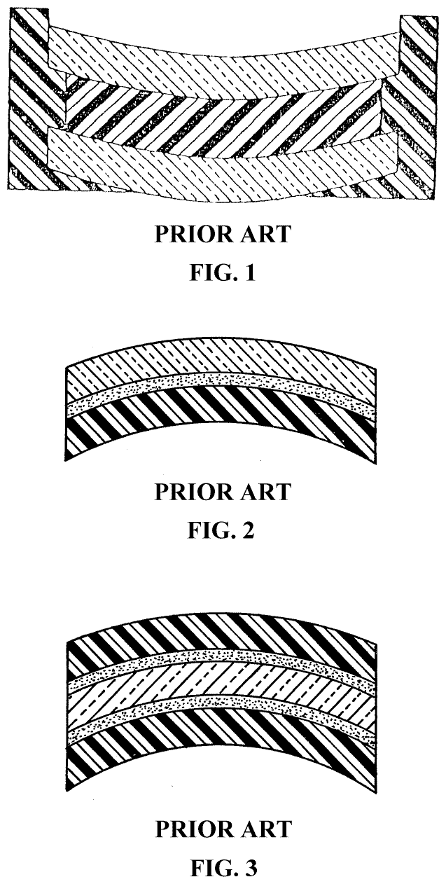

### DETAILED DESCRIPTION OF THE INVENTION

It is noted that a high scratch-resistant and anti-fog combined optical lens device and manufacturing method thereof in accordance with the preferred embodiment of the present invention can be applicable to various glasses (e.g., ophthalmic glasses), various sunglasses, various smart glasses, various sport glasses (e.g., motorcycle-riding glasses), various goggles, various 3D glasses devices, various VR wearable glasses devices, various AR wearable glasses devices or other optical devices, which are not limitative of the present invention.

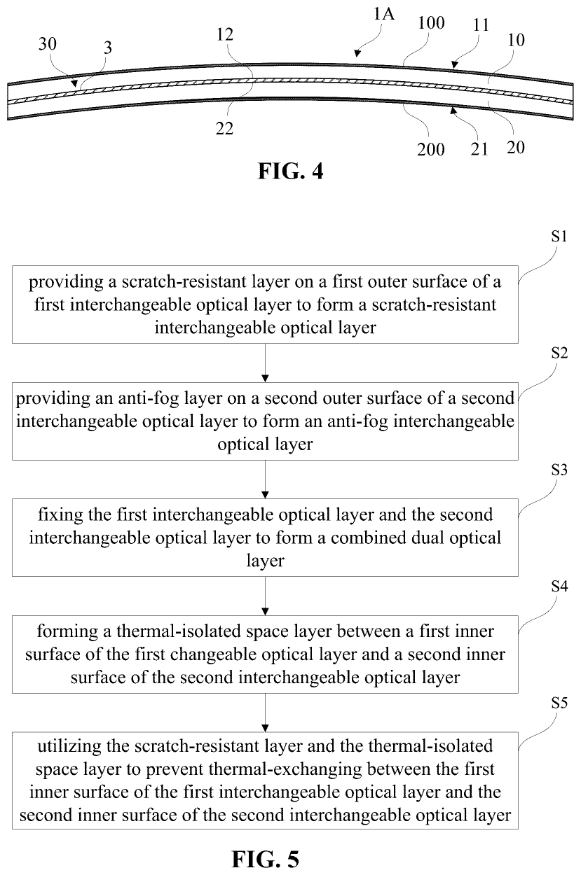

FIG. 4 shows a schematic side view of a high scratch-resistant and anti-fog combined optical lens device in accordance with a first preferred embodiment of the present invention. Referring now to FIG. 4, the high scratch-resistant and anti-fog combined optical lens device in accordance with the first preferred embodiment of the present invention includes a first interchangeable optical layer 10, a second interchangeable optical layer 20 and at least one thermal isolation adhesive layer 3 which are combined to form a combined optical lens device 1A as a high scratch-resistant and anti-fog combined optical lens device.

With continued reference to FIG. 4, by way of example, in wearing, the combined optical lens device 1A is adjusted by selectively changing one of the first interchangeable optical layer 10 and the second interchangeable optical layer 20 in an assembling operation, i.e. adhesion, engaging, screw fixing or other suitable assembling means.

With continued reference to FIG. 4, by way of example, the first interchangeable optical layer 10 has a first outer surface 11 and a first inner surface 12, with the first interchangeable optical layer 10 having a first uniform thickness, a first refractive index and a first hardness and selected from a glass optical layer, a plastic optical layer, a PC (polycarbonate) optical layer, a PMMA (poly(methyl methacrylate)) optical layer, a nylon optical layer, a Tritan optical layer, a Trivex optical layer or other similar material layers thereof.

With continued reference to FIG. 4, by way of example, the first interchangeable optical layer 10 has a first transmittance, a first color (dye color powder), a first pattern, a first mark, a first letter, a first number or combinations thereof. In a preferred embodiment, the first pattern, the first mark, the first letter and the first number are formed from ink dot printing or other equivalent methods.

Still referring to FIG. 4, by way of example, the second interchangeable optical layer 20 has a second outer surface 21 and a second inner surface 22, with the second interchangeable optical layer 20 having a second uniform thickness, a second refractive index and a second hardness and selected from a PC (polycarbonate) optical layer, a PE (polyethylene) optical layer, a PET (polyethylene terphthalates) optical layer, a TAC (tri-acetyl cellulose) optical layer, a CPP (cast polypropylene) optical layer or other similar material layers thereof.

Still referring to FIG. 4, by way of example, the second interchangeable optical layer 20 has a second transmittance, a second color (dye color powder), a second pattern, a second mark, a second letter, a second number or combinations thereof. In a preferred embodiment, the second pattern, the second mark, the second letter and the second number are formed from ink dot printing or other equivalent methods.

Still referring to FIG. 4, by way of example, the second transmittance, the second color, the second pattern, the second mark, the second letter or the second number of the second interchangeable optical layer 20 are corresponding to the first transmittance, the first color, the first pattern, the first mark, the first letter or the first number of the first interchangeable optical layer 10 to perform various transmittance arrangements (i.e., various intensities of snow storms or sunshine), various composite color arrangements, various composite pattern arrangements, various composite letter arrangements, various composite number arrangements or combinations thereof.

Still referring to FIG. 4, by way of example, the first thickness of the first interchangeable optical layer 10 and the second thickness of the second interchangeable optical layer 20 are selectively same or different, with the first interchangeable optical layer 10 and the second interchangeable optical layer 20 supporting the entire structure. In a preferred embodiment, the first refractive index of the first interchangeable optical layer 10 and the second refractive index of the second interchangeable optical layer 20 are selectively same or different.

Still referring to FIG. 4, by way of example, the thermal isolation adhesive layer 3 has a predetermined thickness of thin film or structure to provide at least one thermal isolation space layer or a plurality of thermal isolation space layers. In a preferred embodiment, the thermal isolation adhesive layer 3 is selected from an anti-reflection layer, a polarization thin-film layer, a polarization microstructure layer, a photochromic layer, an anti-blue layer, an anti-blue UV layer, an anti-infrared layer or other functional thin film.

FIG. 5 shows a flow chart of a manufacturing method of high scratch-resistant and anti-fog combined optical lens device in accordance with a preferred embodiment of the present invention, corresponding to the device as best shown in FIG. 4. Turning now to FIGS. 4 and 5, by way of example, the manufacturing method of high scratch-resistant and anti-fog combined optical lens device has a series of procedure (steps S1, S2, S3, S4 and S5) which may be modified according to needs.

Referring now to FIGS. 4 and 5, by way of example, the manufacturing method of high scratch-resistant and anti-fog combined optical lens device of the present invention includes the step S1: providing a scratch-resistant layer 100 on the first outer surface of the first interchangeable optical layer 10 to form a scratch-resistant interchangeable optical layer.

Still referring to FIGS. 4 and 5, by way of example, the scratch-resistant layer 100 is formed from a single layer or multiple layers, with the scratch-resistant layer 100 having a first predetermined thickness and a first predetermined hardness to reinforce a degree of strength of the first interchangeable optical layer 10 and to thereby minimize a total thickness thereof in design, with a first minimized thickness of the scratch-resistant layer 100 providing a degree of optical property to comply with international standards and a degree of protection to avoid crack of the first interchangeable optical layer 10.

Still referring to FIGS. 4 and 5, by way of example, the scratch-resistant layer 100 is made of coating material selected from metal materials (i.e., Al, Au, Ag, Ni, Cr or other suitable metal) or dielectric materials (i.e., HfO₂, Al₂O₃, Ta₂O₅, SiO₂, TiO₂, ZrO₂, TiO₂ or other suitable dielectric materials).

Still referring to FIGS. 4 and 5, by way of example, the scratch-resistant layer 100 is selected from a protective coating layer, a filtering coating layer, an anti-UV coating layer, an anti-blue coating layer, an anti-blue UV coating layer, an anti-infrared coating layer or other functional thin film.

Still referring to FIGS. 4 and 5, by way of example, the manufacturing method of high scratch-resistant and anti-fog combined optical lens device of the present invention further includes the step S2: providing an anti-fog layer 200 on the second outer surface 21 of the second interchangeable optical layer 20 to form a second anti-fog interchangeable optical layer.

Still referring to FIGS. 4 and 5, by way of example, the anti-fog layer 200 is formed from a single layer or multiple layers, with the anti-fog layer 200 having a second predetermined thickness, with the anti-fog layer 200 providing a degree of anti-fog property to reduce a degree of surface tension of waterdrops.

Still referring to FIGS. 4 and 5, by way of example, the manufacturing method of high scratch-resistant and anti-fog combined optical lens device of the present invention further includes the step S3: fixing the first interchangeable optical layer 10 and the second anti-fog interchangeable optical layer 20 to form a combined dual optical layer 1A.

Still referring to FIGS. 4 and 5, by way of example, the manufacturing method of high scratch-resistant and anti-fog combined optical lens device of the present invention further includes the step S4: forming a thermal-isolated space layer 30 between the first inner surface 12 of the first interchangeable optical layer 10 and the second inner surface 22 of the second anti-fog interchangeable optical layer 20.

With continued reference to FIGS. 4 and 5, by way of example, the thermal-isolated space layer 30 is provided to contain at least one thermal isolation adhesive dot, at least one array of thermal isolation adhesive dots, at least one thermal isolation adhesive layer, at least one thermal isolation adhesive frame (i.e., foam ring frame or dot ink) or combinations thereof.

With continued reference to FIGS. 4 and 5, by way of example, the thermal-isolated space layer 30 is combined with at least one functional layer which is selected from a micro-structure layer (i.e., polarization micro-structure or letters), a microelectromechanical system (i.e., electronic components or others) or combination thereof.

Still referring to FIGS. 4 and 5, by way of example, the manufacturing method of high scratch-resistant and anti-fog combined optical lens device of the present invention includes the step S5: utilizing the scratch-resistant layer 100 and the thermal-isolated space layer 30 to prevent thermal-exchanging between the first inner surface 12 of the first interchangeable optical layer 10 and the second inner surface 22 of the second anti-fog interchangeable optical layer 20.

With continued reference to FIGS. 4 and 5, by way of example, in outdoor use, the scratch-resistant layer 100 and the thermal-isolated space layer 30 can prevent thermal loss from the second anti-fog interchangeable optical layer 20 and the anti-fog layer 200 can reduce a degree of surface tension of waterdrops to avoid forming water fog on the second anti-fog interchangeable optical layer 20 so as to enhance evaporation of waterdrops.

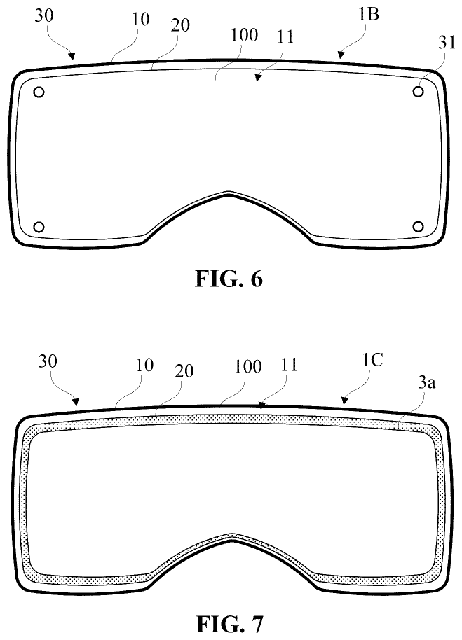

FIG. 6 shows a schematic side view of a high scratch-resistant and anti-fog combined optical lens device in accordance with a second preferred embodiment of the present invention. Turning now to FIG. 6, by way of example, in comparison with the first embodiment, the high scratch-resistant and anti-fog combined optical lens device of the second preferred embodiment of the present invention includes a first interchangeable optical layer 10, a second interchangeable optical layer 20, a thermal-isolated space layer 30 and at least one fixing member 31, with replacing the thermal isolation adhesive layer 3 with the thermal-isolated space layer 30.

With continued reference to FIG. 6, by way of example, the first interchangeable optical layer 10, the second interchangeable optical layer 20, the thermal-isolated space layer 30 and the fixing member 31 are combined to form a combined optical lens device 1B as a high scratch-resistant and anti-fog combined optical lens device which strengthens the whole structure and simplifies an assembling or disassembling process.

With continued reference to FIG. 6, by way of example, the first interchangeable optical layer 10 and the second interchangeable optical layer 20 are assembled or disassembled by at least one fixing member 31 in an assembling or disassembling operation, with the fixing member 31 provided with a pattern or a color.

Referring back to FIGS. 4 and 6, by way of example, in another preferred embodiment, the thermal isolation adhesive layer 3 and the thermal-isolated space layer 30 are provided together, thereby strengthening the whole structure and simplifying an assembling or disassembling process of the high scratch-resistant and anti-fog combined optical lens device.

FIG. 7 shows a schematic side view of a high scratch-resistant and anti-fog combined optical lens device in accordance with a third preferred embodiment of the present invention. Turning now to FIG. 7, in comparison with the first embodiment, the high scratch-resistant and anti-fog combined optical lens device of the third preferred embodiment of the present invention includes a first interchangeable optical layer 10, a second interchangeable optical layer 20 and a thermal-isolated ring frame 3a, as best shown at gray portion in FIG. 7, which are combined to form an airtight thermal-isolated space.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An optical lens device comprising:
a first interchangeable optical layer having a first outer surface and a first inner surface;
a scratch-resistant layer provided on the first outer surface of the first interchangeable optical layer to form a scratch-resistant interchangeable optical layer;
a second interchangeable optical layer having a second outer surface and a second inner surface;
an anti-fog layer on the second outer surface of the second interchangeable optical layer to form a second anti-fog interchangeable optical layer;
a combined dual optical layer formed from fixing the first interchangeable optical layer and the second anti-fog interchangeable optical layer, with arranging the scratch-resistant layer on the first outer surface of the first interchangeable optical layer, with arranging anti-fog layer on the second outer surface of the second interchangeable optical layer; and
a thermal-isolated space layer formed between the first inner surface of the first interchangeable optical layer and the second inner surface of the second anti-fog interchangeable optical layer;
wherein the scratch-resistant layer and the thermal-isolated space layer are provided to prevent thermal-exchanging between the first inner surface of the first interchangeable optical layer and the second inner surface of the second anti-fog interchangeable optical layer.

2. The optical lens device as defined in claim 1, wherein the first interchangeable optical layer has a first transmittance, a first color, a first pattern, a first mark, a first letter, a first number or combinations thereof.

3. The optical lens device as defined in claim 1, wherein the second interchangeable optical layer has a second transmittance, a second color, a second pattern, a second mark, a second letter, a second number or combinations thereof.

4. The optical lens device as defined in claim 1, wherein the thermal-isolated space layer is provided to contain at least one thermal isolation adhesive dot, at least one array of thermal isolation adhesive dots, at least one thermal isolation adhesive layer, at least one thermal isolation adhesive frame or combinations thereof.

5. The optical lens device as defined in claim 1, wherein the first interchangeable optical layer and the second interchangeable optical layer are assembled by at least one fixing member.

6. The optical lens device as defined in claim 1, wherein the anti-fog layer is selected from a protective layer, a filtering layer, an anti-UV layer, an anti-blue layer, an anti-blue purple layer, an anti-IR layer or combinations thereof.

7. The optical lens device as defined in claim 1, wherein the combined dual optical layer is adjusted by selectively changing one of the first interchangeable optical layer and the second interchangeable optical layer in an assembling operation.

8. A manufacturing method for an optical lens device comprising:
providing a scratch-resistant layer on a first outer surface of a first interchangeable optical layer to form a scratch-resistant interchangeable optical layer;
providing an anti-fog layer on a second outer surface of a second interchangeable optical layer to form a second anti-fog interchangeable optical layer;
fixing the first interchangeable optical layer and the second anti-fog interchangeable optical layer to form a combined dual optical layer;
forming a thermal-isolated space layer between a first inner surface of the first interchangeable optical layer and a second inner surface of the second anti-fog interchangeable optical layer; and
utilizing the scratch-resistant layer and the thermal-isolated space layer to prevent thermal-exchanging between the first inner surface of the first interchangeable optical layer and the second inner surface of the second anti-fog interchangeable optical layer.

9. The method as defined in claim 8, wherein the first interchangeable optical layer has a first transmittance, a first color, a first pattern, a first mark, a first letter, a first number or combinations thereof.

10. The method as defined in claim 8, wherein the second interchangeable optical layer has a second transmittance, a second color, a second pattern, a second mark, a second letter, a second number or combinations thereof.

11. The method as defined in claim 8, wherein the thermal-isolated space layer is processed in an assembling procedure to contain at least one thermal isolation adhesive dot, at least one array of thermal isolation adhesive dots, at least one thermal isolation adhesive layer, at least one thermal isolation adhesive frame or combinations thereof.

12. The method as defined in claim 8, wherein the first interchangeable optical layer and the second interchangeable optical layer are assembled or disassembled by at least one fixing member in an assembling or disassembling operation.

13. The method as defined in claim 8, wherein the anti-fog layer is selected from a protective layer, a filtering layer, an anti-UV layer, an anti-blue layer, an anti-blue purple layer, an anti-IR layer or combinations thereof.

14. The method as defined in claim 8, wherein the combined dual optical layer is adjusted by selectively changing one of the first interchangeable optical layer and the second interchangeable optical layer in an assembling operation.
